(19) United States
(12) Patent Application Publication
(10) Pub. No.: US 2002/0092225 A1
(43) Pub. Date: Jul. 18, 2002

(54) Fly rod with different flexural rigidity

(76) Inventor: Akio Watanabe, Sayama-shi (JP)

Correspondence Address: VENABLE, BAETJER, HOWARD & CIVILETTI, LLP, P.O. Box 34385, Washington, DC, 20043-9998, US

(21) Appl. No.: 09/938,508

(22) Filed: Aug. 27, 2001

(30) Foreign Application Priority Data
Nov. 27, 2000 (JP) 2000-402984

(51) Int. Cl. A01K 87/00

(52) U.S. Cl. 43/18.1

(57) ABSTRACT

A rod for fly-fishing is disclosed. The rod has a flexural rigidity of a fly rod of a transverse direction right-angled in the direction to cast a fly line and fly toward an intended target is different from the flexural rigidity of the fly rod in the direction to cast the fly line and fly toward the intended target.

### BACKGROUND OF THE INVENTION

1. Field of the Invention

This invention relates to a fishing rod, more specifically it relates to a fly fishing rod.

2. Description of the Related Art

A conventional fly rod is made so that it bends equally in any direction. Therefore, the cross section of the fly rod is one of a regular polygon form or a circular form. And the fly rod is flexibly made to cast a fly line and fly toward an intended target.

In fly-fishing, usually, when the intended target is a long distance away, an angler repeats the false-cast several times and then casts the fly line and fly toward the intended target. And when the intended target is a short distance away, the angler casts the fly line and fly toward the intended target by a forward cast motion following a singular back cast motion. Regardless of the distance, the angler moves his arm with his rod forward and backward, and then casts the fly line and fly toward the intended target.

Therefore, if a caster casts the fly line and fly toward the intended target with the fly rod, the small unnecessary sideways motion of the arm of the caster is amplified into the large sideways motion of the flexible rod tip of the fly rod. Or, if a side wind blows between the target and the caster, the fly rod is so flexible that the rod tip is bent in a sideways direction in relation to the strength of the side wind.

That is, the fly rod used now has the disadvantage that the casted fly line and fly is shifted easily from the direction toward a target by a large sideways motion that is amplified into the sideways motion of the rod tip by the flexibility of the fly rod.

The object of this invention is to provide a fly rod with which a caster is able to cast a fly line and fly toward and to an intended target easily and more accurately.

### SUMMARY OF THE INVENTION

In order to accomplish the aforementioned object, the flexural rigidity of the fly rod of the transverse direction right-angled in the direction to cast the fly line and fly toward the intended target is made larger than the flexural rigidity of the fly rod of the direction to cast the fly line and fly toward the intended target.

That is, the cross section of the fly rod is that the moment of inertia of area of the cross section of the fly rod around the vertical axis passing through a center of the cross section of the fly rod is made larger than the moment of inertia of area of the cross section of the fly rod around the horizontal axis passing through a center of the cross section of the fly rod.

Here, Young's modulus of the material of the fly rod is set to E, the moment of inertia of area of the cross section of the fly rod is set to “I” then the flexural rigidity is shown by formula (1).

Flexural rigidity=E×I (1)

And then the moment of inertia of area of the cross section of the fly rod around the perpendicular axis is set to “I_{y}”, the moment of inertia of area of the cross section of the fly rod around the horizontal axis is set to “Iₓ”. The “I_{y}” is larger than the “Iₓ”. So, it becomes clear by formula (1) that the flexural rigidity of the fly rod around the perpendicular axis (E I_{y}) is larger than the flexural rigidity of the fly rod around the horizontal axis (E Iₓ).

And, the flexural rigidity of the fly rod around the perpendicular axis (E I_{y}) is the flexural rigidity of the fly rod of the transverse direction right-angled in the direction to cast the fly line and fly toward the intended target, and the flexural rigidity of the fly rod around the horizontal axis (E Iₓ) is the flexural rigidity of the fly rod of the direction to cast the fly line and fly toward the intended target.

Thus, the flexural rigidity of the fly rod of the transverse direction right-angled in the direction to cast the fly line and fly toward the intended target becomes large, so the small unnecessary sideways motion is not amplified into the large sideways motion of the rod tip. Therefore, the caster is able to cast the fly line and fly toward the intended target easily and more accurately.

### BRIEF DESCRIPTION OF THE DRAWINGS

For a more complete understanding of the present invention and for further features and advantages, reference is now made to the following description taken in conjunction with the accompanying drawings, in which:

FIG. 1A shows a cross sectional view of an embodiment of the fly rod in this invention;

FIG. 1B shows a cross sectional view of another embodiment of the fly rod in this invention;

FIG. 2A shows a cross sectional view of a conventional fly rod;

FIG. 2B shows a cross sectional view of another conventional fly rod;

FIG. 3 shows somewhat enlarged cross sectional view of the fly rod shown in FIG. 1A;

FIG. 4A shows detailed cross sectional view of the element member “a1” shown in FIG. 3;

FIG. 4B shows detailed cross sectional view of the element member “a2” shown in FIG. 3;

FIG. 4C is a cross sectional view of the element member “a3”;

FIG. 5A is a perspective view of the element member “a1”;

FIG. 5B is a perspective view of the element member “a2”;

FIG. 6 shows the method to bundle the element members into one integrated rod.

### DETAILED DESCRIPTION OF PREFERRED EMBODIMENT

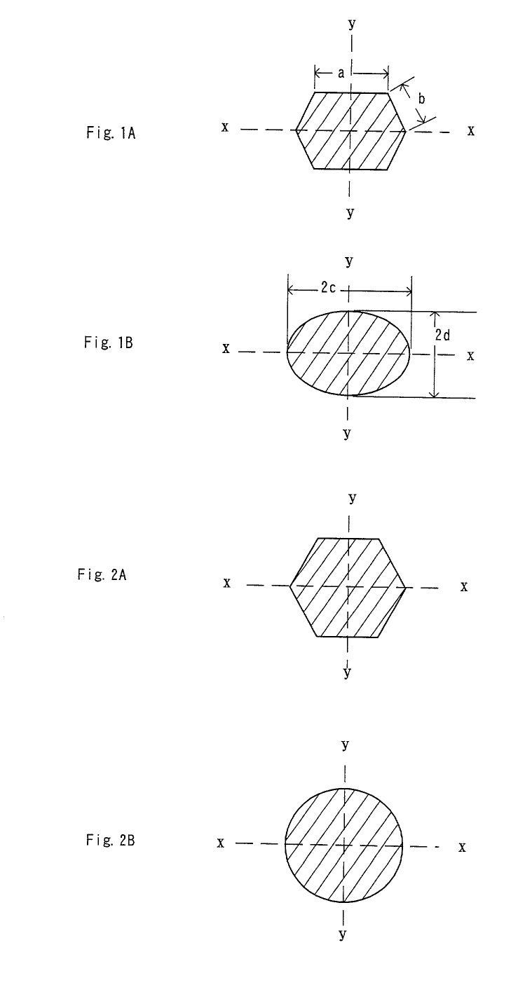

Referring to the drawings, the present invention will be specifically described hereinbelow. FIG. 1A shows a cross sectional view of an embodiment of the fly rod in this invention. The cross section shows a none-regular hexagon form. The line (y-y) is a perpendicular axis passing through a center of the cross section of the fly rod; the line (x-x) is the horizontal axis passing through a center of the cross section of the fly rod. In FIG. 1A, the length of the long sides parallel to the horizontal axis (x-x) is set to “a”, and the length of the other short sides is set to “b”.

And then the moment of inertia of area of the cross section of the fly rod around the perpendicular axis is set to “I_{y}”, the moment of inertia of area of the cross section of the fly rod around the horizontal axis is set to “Iₓ”. The “I_{y}” and “Iₓ” is shown by the following expression (1), (2).

$$\begin{matrix}{I}_{y} = \frac{\sqrt{3}}{48} ( {b}^{4} + 4 {ab}^{3} + 6 {a}^{2} {b}^{2} + 4 {a}^{3} b ) & ( 1 ) \\ {I}_{x} = \frac{\sqrt{3}}{16} ( {b}^{4} + 4 {ab}^{3} ) & ( 2 )\end{matrix}$$

Here, “a” is longer than “b”, therefore, according to this embodiment, the moment of inertia of area of the cross section of the rod around the perpendicular axis (y-y) “I_{y}”, becomes larger than the moment of inertia of area of the cross section of the rod around the horizontal axis (x-x) “Iₓ”. In addition, as long as it is the form which the moment of inertia of area of the cross section of the fly rod around the perpendicular axis of the fly rod is made to become larger than the moment of inertia of area of the cross section of the fly rod around the horizontal axis of the fly rod. Any kind of non-regular polygon form which meets “I_{y}>Iₓ” can be applied to this invention.

FIG. 1B shows a cross sectional view of another embodiment of the fly rod in this invention. The cross section form is an ellipsoid. The long axis of the ellipse is set to “2c” and the short axis of the ellipse is set to “2d”. And then the moment of inertia of area of the cross section of a fly rod around the perpendicular axis (y-y) is set to “I_{y}”, the moment of inertia of area of the cross section of the fly rod around the horizontal axis (x-x) is set to “Iₓ”. The I_{y} and Iₓ are shown by the following expression (3), (4).

$${I}_{y} = \frac{π}{4} {c}^{3} d \qquad ( 3 )$$

According to this embodiment “2c” is longer than “2d”, therefore, the moment of inertia of area of the cross section of the rod around the perpendicular axis (y-y) “I_{y}” becomes larger than the moment of inertia of area of the cross section of the rod around the horizontal axis (x-x) “Iₓ”.

In FIGS. 1A and 1B, the “I_{y} ” is larger than the “Iₓ”, therefore, the flexural rigidity of the fly rod around the perpendicular axis (E I_{y}) is larger than the flexural rigidity of the fly rod around the horizontal axis (E Iₓ). (Here, “E” is Young's modulus of the material of the fly rod.)

That is, the flexural rigidity of the fly rod to the perpendicular axis is the flexural rigidity of the fly rod of the transverse direction right-angled in the direction to cast the fly line and fly toward the intended target, and the flexural rigidity of the fly rod to the horizontal axis is the flexural rigidity of the fly rod of the direction to cast the fly line and fly toward the intended target.

Thus, the fly rod which has the cross section form of this invention has that the flexural rigidity of the fly rod of the transverse direction right-angled in the direction to cast (the flexural rigidity of the fly rod around the perpendicular axis) is larger than the flexural rigidity of the fly rod of the direction to cast (the flexural rigidity of the fly rod around the horizontal axis).

Therefore, the fly rod according to this invention has the characteristic that it is hard to bend to the transverse direction. That is, when a caster casts the fly line and fly toward the target with the fly rod, the small sideways motion of the caster is not amplified into the large sideways motion of the rod tip, so the caster is able to cast easily and more correctly toward the intended target.

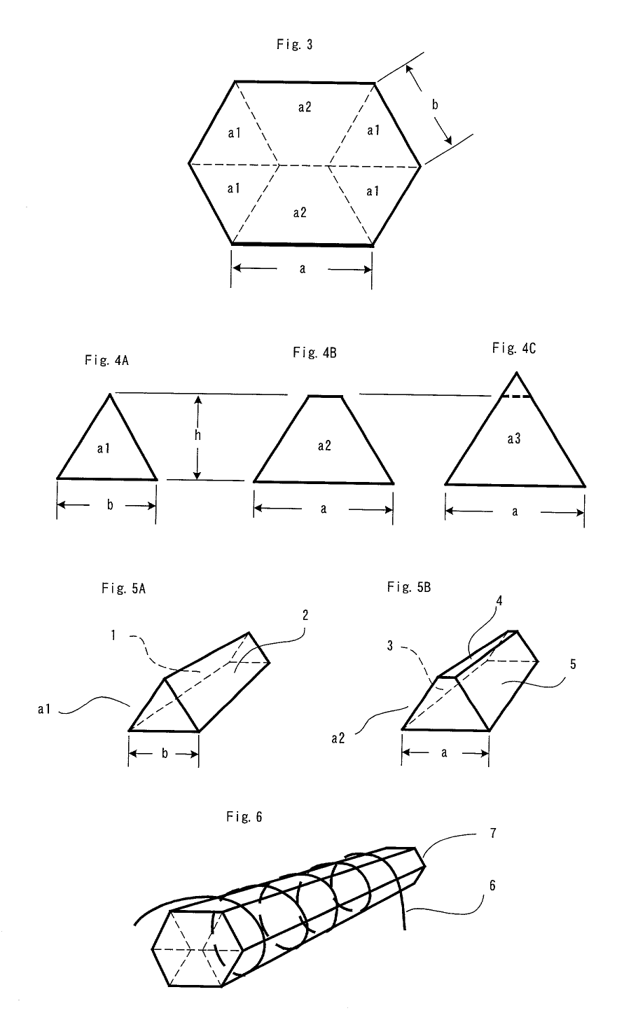

Referring to FIGS. 3 to 6, a method of forming a fly rod having hexagonal cross section will be explained. FIG. 3 shows a somewhat enlarged cross sectional view of the fly rod shown in FIG. 1A. The fly rod is composed of four element members “a1” which has the regular triangle form in cross section and also has “b” in length of each side, and two element members “a2” which has the trapezoid form in cross section and also has “a” in length of base side. FIGS. 4A and 4B show a cross sectional view of the element member “a1” and “a2”. FIGS. 5A and 5B show a perspective view of the element member “a1” and “a2”. The letter “h” in FIG. 4A denotes the height of the element member “a1”. FIG. 4C is a cross sectional view of the element member “a3” which has “a” in the length of each side.

As shown in FIGS. 4A, 4B and FIGS. 5A, 5B, “a2” is made from element member “a3” which has the regular triangle form in cross section. That is, the element member “a2” has the trapezoid form in cross section. One of the corners of element member “a3” is cut and turns into trapezoid form in cross section. The full length of the height of element member “a2” is equal to the height of “a1”. FIGS. 5A and 5B show a perspective view of the element member “a1” and “a2”, respectively. “1” and “2” denote each side surface of the element member “a1”. And then, “3” and “5” denote each side surface of the element member “a2” and “4” denotes the upper surface of the element member “a2”.

The method of making the element member “a1” and “a3” is well known. At first, split bamboo culms into the six element members and then plane each element member to have the triangle form in cross section. The four of the six element members have the regular triangle form in cross section; the length of each side is “b” (element member “a1”). Another two of the six element members have the regular triangle form in cross section; the length of each side is “a” (element member “a3”).

And the element member “a2” is made of the element member “a3”. Then, put the adhesive agent (for example, glue or Epoxies) to the side surface “1” and “2” of the element member “a1”, and to the side surface “3”, “5” and the upper surface “4” of the element member “a2”. And glue all the element members (“a1” is four element members and “a2” is two element members) together in the turn in FIG. 3. After glue is cured, then, the integrated element members are bonded with binding cord spirally as shown in FIG. 6.

Thus, the fly rod providing the different moments of inertia of area of the cross section can be made.

While various embodiments of the invention have been shown and described, it will be apparent to those skilled in the art that numerous alterations may be made without departing from the inventive concepts presented herein. Thus, the invention is not to be limited except in accordance with the following claims and their equivalents.

What is claimed is:

1. A fly rod with a resilient rod portion between the tip where an end of fly line is to be secured and the grip, in the full length or a part of the length of the resilient rod portion, the moment of inertia of area of each cross section of the fly rod around a perpendicular axis passing through a center of the cross section of the resilient rod portion is larger than the moment of inertia of the area of each cross section of the fly rod resilient rod portion around a horizontal axis passing through the center of the cross section of the resilient rod portion,
thereby the flexural rigidity transverses horizontally in a right-angle to the rod which cast the fly line and fly to the intended target becomes larger than the flexural rigidity situated in the direction of the rod.

2. A fly rod according to claim 1, the cross section of the rod has none-regular polygon or ellipsoid.

3. A fly rod according to claim 1, materials of the resilient rod portion is bamboo.

4. A fly rod according to claim 3, the resilient rod portion integrates element members of bamboo.

5. A fly rod according to claim 3, the resilient rod portion is glued and bonded by a code.
